(19) United States
(12) Patent Application Publication
(10) Pub. No.: US 2023/0169873 A1
(43) Pub. Date: Jun. 1, 2023

(54) FLIGHT MANAGEMENT APPARATUS AND FLIGHT MANAGEMENT METHOD

(71) Applicant: KDDI CORPORATION, Tokyo (JP)

(72) Inventor: Takaya TANAKA, Tokyo (JP)

(73) Assignee: KDDI CORPORATION, Tokyo (JP)

(21) Appl. No.: 17/985,380

(22) Filed: Nov. 11, 2022

(30) Foreign Application Priority Data
Nov. 30, 2021 (JP) 2021-194004

(51) Int. Cl. G08G 5/00

(52) U.S. Cl. CPC G08G 5/0034; G08G 5/0069

(57) ABSTRACT

A flight management apparatus having a storage unit that stores flight plan information indicating a flight plan for a flying vehicle, including a scheduled flight route for the flying vehicle; an acquisition unit that acquires position information indicating a position of the flying vehicle from the flying vehicle before the flying vehicle flies based on the flight plan; a setting unit that sets an additional flight plan including an additional flight route from the position indicated by the position information acquired by the acquisition unit to a prescribed position on the scheduled flight route included in the flight plan; and an output unit that outputs additional flight plan information indicating the additional flight plan set by the setting unit.

### CROSS REFERENCE TO RELATED APPLLICATION

Priority is claimed on Japanese Patent Application No. 2021-194004, filed Nov. 30, 2021, the content of which is incorporated herein by reference.

### BACKGROUND OF THE INVENTION

### Field of the Invention

The present invention relates to a flight management apparatus and a flight management method for managing the flight of a flying vehicle.

### Description of Related Art

Conventionally, flying vehicles are flown based on preset flight plans for the flying vehicles. For example, Japanese Patent Publication No. 6810488 discloses flying a flying vehicle that is housed in a housing apparatus based on a preset flight plan.

### SUMMARY OF THE INVENTION

An example of objective of this disclosure is to allow a flying vehicle to fly without reducing the convenience to the user.

The flight management apparatus according to a first aspect of this disclosure has a storage unit that stores flight plan information indicating a flight plan for a flying vehicle, including a scheduled flight route for the flying vehicle; an acquisition unit that acquires position information indicating a position of the flying vehicle from the flying vehicle before the flying vehicle flies based on the flight plan; a setting unit that sets an additional flight plan including an additional flight route from the position indicated by the position information acquired by the acquisition unit to a prescribed position on the scheduled flight route included in the flight plan; and an output unit that outputs additional flight plan information indicating the additional flight plan set by the setting unit.

The setting unit may set the additional flight plan including the additional flight route from the position indicated by the position information acquired by the acquisition unit to a position of a starting point of the scheduled flight route included in the flight plan.

The setting unit may set the additional flight plan by receiving approval for the additional flight plan from a user of the flying vehicle.

The setting unit may receive the additional flight route from the user of the flying vehicle and may set the additional flight plan including the received additional flight route.

The setting unit may set the additional flight plan if a post-addition flight plan, which is a flight plan obtained by adding the additional flight plan to the flight plan, satisfies a first condition.

The setting unit may identify a remaining capacity of a battery provided in the flying vehicle, and may set the additional flight plan if the first condition, which includes a relationship between the identified remaining capacity of the battery and the post-addition flight plan being a prescribed relationship, is satisfied.

The setting unit may set the additional flight plan if an amount of consumable power required for the flying vehicle to fly in accordance with the post-addition flight plan is less than the identified remaining capacity of the battery.

The flight plan may include an execution plan for a prescribed action that can be executed by the flying vehicle; and the setting unit may set the additional flight plan if the first condition, which includes the flying vehicle being able to perform the prescribed action scheduled to be executed by the execution plan included in the post-addition flight plan, is satisfied.

The flight plan may include time information indicating a time at which the flying vehicle is to fly at the prescribed position on the scheduled flight route; and the setting unit may set the additional flight plan if the first condition, which includes the flying vehicle being able to fly at the prescribed position at the time at which to fly at the prescribed position indicated by the time information included in the flight plan, is satisfied.

The setting unit may set the additional flight plan if the first condition, which includes the flying vehicle being able to communicate with the flight management apparatus on the scheduled flight route indicated by the additional flight plan, is satisfied.

The setting unit may set the additional flight plan if a vicinity of the position indicated by the position information acquired by the acquisition unit satisfies a second condition.

The setting unit may set the additional flight plan if the second condition, indicating that the vicinity of the position indicated by the position information acquired by the acquisition unit is an environment in which the flying vehicle can communicate, is satisfied.

The setting unit may set the additional flight plan including the additional flight route, including a route ascending from the position indicated by the position information acquired by the acquisition unit to a position directly above the position and at the same altitude as the prescribed position.

The output unit may transmit post-addition flight plan information indicating a post-addition flight plan, which is a flight plan obtained by adding the additional flight plan set by the setting unit to the flight plan, to the flying vehicle before flying.

The flight management method according to a second aspect of this disclosure, to be executed by a computer, has storing, in a storage unit, flight plan information indicating a flight plan for a flying vehicle, the flight plan information including a scheduled flight route for the flying vehicle in the flight plan; acquiring position information indicating a position of the flying vehicle from the flying vehicle before the flying vehicle flies based on the flight plan; setting an additional flight plan including an additional flight route from a position indicated by the acquired position information to a prescribed position on the scheduled flight route included in the flight plan; and a outputting additional flight plan information indicating the additional flight plan that was set.

### BRIEF DESCRIPTION OF THE DRAWINGS

FIG. 1 is a diagram illustrating an outline of a flying vehicle management system.

FIG. 2 is a diagram illustrating a functional structure of a flying vehicle management apparatus

FIG. 3 is a diagram illustrating an example of flight plan information.

FIG. 4 is a sequence diagram indicating the flow of processing in the flight management system.

### DETAILED DESCRIPTION OF THE INVENTION

### [Outline of Flight Management System S]

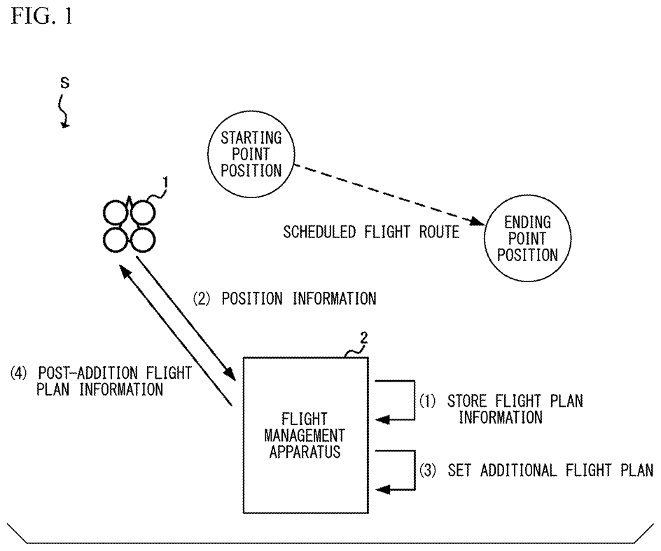

FIG. 1 is a diagram illustrating an outline of a flight management system S.

The flight management system S is a system for managing the flight of a flying vehicle 1, the system having the flying vehicle 1 and a flight management apparatus 2. The flight management apparatus 2 is a computer that manages the flight of the flying vehicle 1, providing a flight management service for managing the flight of the flying vehicle 1.

In FIG. 1, only one flying vehicle 1 is illustrated. However, the flight management system S may have multiple flying vehicles 1.

The flight management apparatus 2 receives, in advance, a registration of a flight plan indicating a scheduled flight route of the flying vehicle 1, including a starting point position and an ending point position, from the user of the flying vehicle 1, and thereby stores the flight plan information indicating the flight plan ((1) in FIG. 1). The flight management apparatus 2 acquires position information indicating the position of the flying vehicle 1 from the flying vehicle 1 before the flying vehicle 1 flies based on the flight plan of the flying vehicle 1 ((2) in FIG. 1).

The flight management apparatus 2 sets an additional flight plan including an additional flight route, which is a flight route from the position of the flying vehicle 1 indicated by the acquired position information to the position of the starting point of the scheduled flight route included in the flight plan ((3) in FIG. 1).

The flight management apparatus 2 transmits, to the flying vehicle 1, post-addition flight plan information indicating the post-addition flight plan, which is a flight plan obtained by adding the additional flight plan that has been set to the flight plan ((4) in FIG. 1). Thereafter, the flying vehicle 1 flies based on the post-addition flight plan indicated by the post-addition flight plan information that has been received.

In the conventional art, when flying a flying vehicle 1 based on a flight plan, the flying vehicle 1 required to be housed in a housing apparatus. In contrast therewith, in a state in which a housing apparatus is designated as the starting point position of a scheduled flight route, the flight management apparatus 2 in the flight management system S can make the flying vehicle 1 fly to the starting point position of the scheduled flight route based on an additional flight plan, and then fly based on the flight plan indicated by the flight plan information, even in the case in which the flying vehicle 1 is not housed in the housing apparatus. Therefore, the flight management system S can make the flying vehicle 1 fly without reducing the convenience to the user of the flying vehicle 1.

Hereinafter, details regarding the structure of the flight management apparatus 2 will be explained.

### [Functional Structure of Flight Management Apparatus 2]

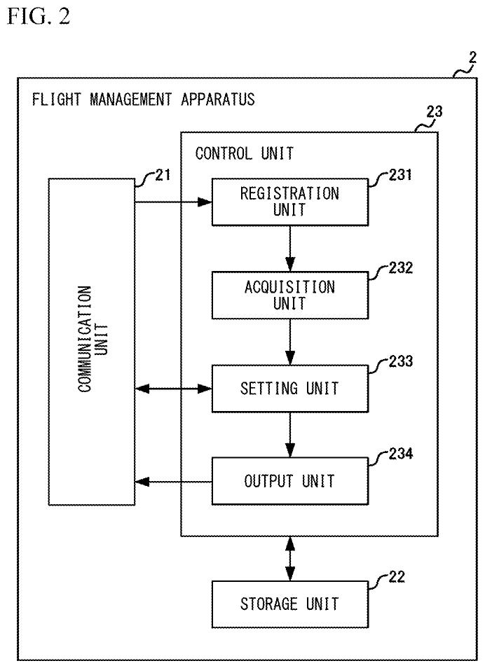

FIG. 2 is a diagram illustrating the functional structure of the flight management apparatus 2. The flight management apparatus 2 has a communication unit 21, a storage unit 22, and a control unit 23. The control unit 23 has a registration unit 231, an acquisition unit 232, a setting unit 233, and an output unit 234.

The communication unit 21 is a communication interface for transmitting and receiving data to and from the flying vehicle 1 over a communication network such as a mobile telephone line or the internet.

The storage unit 22 is a storage medium that stores various types of data, having a ROM (Read-Only Memory), a RAM (Random Access Memory), and a hard disk or the like. The storage unit 22 stores a program executed by the control unit 23. The storage unit 22 stores the program for making the control unit 23 function as the registration unit 231, the acquisition unit 232, the setting unit 233, and the output unit 234.

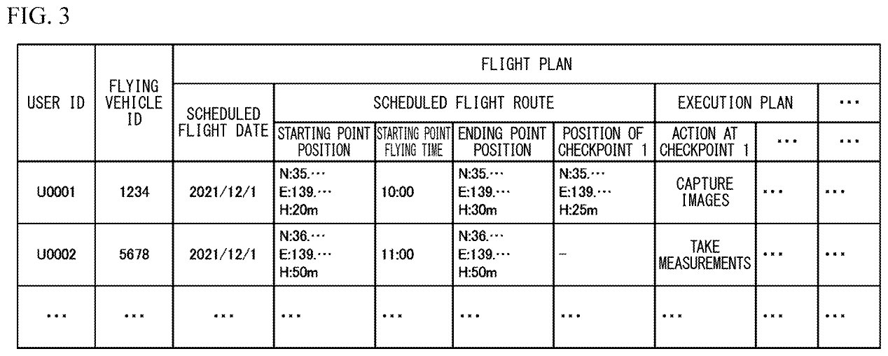

Additionally, the storage unit 22 stores flight plan information indicating the flight plan of the flying vehicle 1 including the scheduled flight route of the flying vehicle 1 in response to control by the control unit 23. FIG. 3 is a diagram illustrating an example of flight plan information. As illustrated in FIG. 3, the flight plan information is information in which a user ID for identifying the user of the flying vehicle 1, a flying vehicle ID for identifying the flying vehicle 1, and the flight plan of the flying vehicle 1 are associated with each other.

The flight plan includes, for example, a scheduled flight date of the flying vehicle 1, route information indicating a scheduled flight route, and an execution plan indicating actions to be executed by the flying vehicle 1. The route information includes a starting point position of the scheduled flight route, a starting point flying time, which is the time at which the flying vehicle 1 is to fly at the starting point position, an ending point position of the scheduled flight route, and the respective positions of one or more checkpoints. The starting point position, the ending point position, and the positions of the checkpoints include, for example, information indicating the latitude, the longitude, and the altitude. The positions of the checkpoints are categories that can optionally be registered by the user, and do not required to be included in the route information. Additionally, the execution plan includes action information indicating the actions of the flying vehicle 1 at each of the one or more checkpoints.

The execution plan is information indicating prescribed actions that the flying vehicle 1 is to execute at the starting point, at the ending point, or at the one or more checkpoints, and is, for example, information in which point identification information for identifying each of the starting point, the ending point, and the one or more checkpoints is associated with information indicating prescribed actions. The prescribed actions are, for example, actions such as image capture, measurement, equipment inspection, and the like. The prescribed actions may not be performed at all of the starting point, the ending point, and the one or more checkpoints, or may be executed at some of the starting point, the ending point, and the one or more checkpoints. Additionally, the prescribed actions may include charging actions at charging facilities serving as checkpoints.

The control unit 23 is, for example, a CPU (Central Processing Unit). The control unit 23 functions as the registration unit 231, the acquisition unit 232, the setting unit 233, and the output unit 234 by executing a program stored in the storage unit 22.

### [Registration of Flight Plan]

First, the process by which the flight management device 2 registers a flight plan will be explained. The registration unit 231 registers a flight plan, for example, from a user terminal (not illustrated) used by the user of the flying vehicle 1, by receiving the flight plan from the flying vehicle 1.

Specifically, the registration unit 231 authenticates a login of the user by receiving, from the user terminal, a password and a user ID issued to the user by the flight management service. When login authentication succeeds, the registration unit 231 displays an input screen for receiving the flight plans on the user terminal, and receives the flying vehicle ID of the flying vehicle 1 and the flight plan of the flying vehicle 1 by means of the input screen.

As mentioned above, the flight plan includes the scheduled flight date on which the flying vehicle 1 is to fly, the scheduled flight route of the flying vehicle 1, and an execution plan. For example, the registration unit 231 receives, as the scheduled flight route, the starting point position, the ending point position, the starting point flying time, and the positions of each of the one or more checkpoints. Additionally, the registration unit 231 receives, as the execution plan for the prescribed actions, information indicating prescribed actions to be executed by the flying vehicle 1 at each of the one or more checkpoints. The registration unit 231 stores, in the storage unit 22, flight plan information in which the user ID of the user of the flying vehicle 1, the flying vehicle ID of the flying vehicle 1 received via the input screen, and the flight plan are associated with each other.

### [Setting of Additional Flight Plan]

Next, the process by which an additional flight plan is set will be explained. The acquisition unit 232 and the setting unit 233 cooperate to set an additional flight plan including an additional flight route to a prescribed position on the scheduled flight route included in the flight plan of the flying vehicle 1.

The acquisition unit 232 acquires, from the flying vehicle 1, flying vehicle position information indicating the position of the flying vehicle 1 before the flying vehicle 1 flies based on the flight plan. For example, the acquisition unit 232 transmits, to the flying vehicle 1 with the flying vehicle ID associated with the flight plan information, an acquisition request for flying vehicle position information a prescribed time period before the starting point flying time included in the flight plan indicated by the flight plan information. Upon receiving the acquisition request for the flying vehicle position information, the flying vehicle 1 identifies its own position and transmits flying vehicle position information indicating said position to the flight management apparatus 2. The flying vehicle position information includes a latitude, a longitude, and an altitude indicating the position of the flying vehicle 1. The acquisition unit 232 acquires the flying vehicle position information from the flying vehicle 1.

If the position of the flying vehicle 1 indicated by the flying vehicle position information acquired by the acquisition unit 232 differs from the starting point position on the scheduled flight route included in the flight plan of the flying vehicle 1, then the setting unit 233 sets an additional flight plan including an additional flight route from the position of the flying vehicle 1 to a prescribed position on the scheduled flight route. The prescribed position on the scheduled flight route may be the starting point position of the scheduled flight route, or a position other than the starting point position, such as a position near the starting point. The setting unit 233 sets an additional flight plan indicating the additional flight route from the position of the flying vehicle 1 indicated by the flying vehicle position information acquired by the acquisition unit 232 to the starting point position of the scheduled flight route. The setting unit 233, for example, sets the additional flight plan by adding additional plan information indicating the additional flight route to the flight plan indicated by the flight plan information.

The setting unit 233 tentatively sets a post-addition flight plan, which is a flight plan with the additional flight plan added to the flight plan, and sets the additional flight plan if the tentatively set post-addition flight plan satisfies a first condition. The first condition is, for example, that the remaining capacity of a battery provided in the flying vehicle 1 and the post-additional flight plan have a prescribed relationship.

For example, first, the setting unit 233 communicates with the flying vehicle 1 and acquires, from the flying vehicle 1, information indicating the remaining capacity of the battery provided in the flying vehicle 1, thereby identifying the remaining capacity of the battery provided in the flying vehicle 1. The setting unit 233 sets an additional flight plan if the first condition, indicating that the relationship between the remaining capacity of the battery that has been identified and the post-addition flight plan is a prescribed relationship, is satisfied. Specifically, the setting unit 233 sets the additional flight plan if, based on the post-addition flight plan, the amount of consumable power required for the flying vehicle 1 to fly from the current position to the starting point position of the scheduled flight route, and then to fly to the ending point position in accordance with the scheduled flight route is less than the remaining capacity in the battery of the flying vehicle 1 that has been identified. By setting the additional flight plan on the condition that such a condition is satisfied, the flying vehicle 1 can complete the flight based on the flight plan even when starting to fly from the current position.

Although the setting unit 233 computed the amount of consumable power required for the flying vehicle 1 to fly the scheduled flight route based on the amount of consumable power required for the flying vehicle 1 to fly from the current position to the starting point position of the scheduled flight route, and then to fly from the starting point position of the scheduled flight route to the ending point position, this disclosure is not limited thereto. If the position of a facility for charging the battery of the flying vehicle 1 is included as a checkpoint on the scheduled flight route and the execution plan includes the flying vehicle 1 charging at said facility, then the setting unit 233 may compute, as the amount of consumable power required for the flying vehicle 1 to fly the scheduled flight route, the amount of consumable power required for the flying vehicle to fly from the current position to the starting point position of the scheduled flight route, and then to fly to the position of said facility in accordance with the scheduled flight route.

Additionally, when setting the additional flight plan, the setting unit 233 sets an additional flight plan indicating an additional flight route including a vertical ascent route rising from the position indicated by the position information acquired by the acquisition unit 232 to a position that is directly above said position and at the same altitude as the prescribed position. For example, the setting unit 233 sets an additional flight plan including the vertical ascent route and a horizontal flight route for flying to the prescribed position on a line segment from the position that is directly above the position indicated by the position information acquired by the acquisition unit 232 and at the same altitude as the prescribed position. By doing so, even if there is an obstacle, such as a building, blocking the flight of the flying vehicle 1 between the position of the flying vehicle 1 and the position of the starting point of the scheduled flight route, the probability that the flying vehicle 1 will avoid said obstacle when flying can be raised, and the flying vehicle 1 can be kept from colliding with the obstacle.

Additionally, the setting unit 233 may set the additional flight plan by receiving approval for the additional flight plan from the user of the flying vehicle 1. For example, the setting unit 233 displays, on the user terminal, an approval reception screen for receiving approval of the additional flight plan, including the additional flight route, and receives approval of the additional flight plan via the approval reception screen. The setting unit 233 sets the reception of approval for the additional flight plan as a condition for setting the additional flight plan. By doing so, the flight management apparatus 2 can set the additional flight plan after having made the user understand the additional flight plan.

The setting unit 233 determines that the tentatively set post-addition flight plan has been finalized on the condition that approval for the additional flight plan has been received, and updates the flight plan indicated by the flight plan information with the post-addition flight plan.

The first condition may include another condition different from the condition that the remaining capacity of the battery in the flying vehicle 1 must be greater than the amount of the consumable power in the flying vehicle 1 consumed by the post-addition flight plan. For example, the first condition may include the condition that the flying vehicle 1 be able to realize prescribed actions scheduled to be performed by a prescribed action execution plan included in the post-addition flight plan.

In this case, for example, power consumption information indicating the amount of power consumed by the flying vehicle 1 when performing each of multiple prescribed actions is stored in the storage unit 22. Furthermore, the setting unit 233 refers to the power consumption information and to the execution plan for prescribed actions included in the post-addition flight plan, and identifies the amount of power consumed by each of the one or more prescribed actions that are scheduled to be executed. The setting unit 233 sums the identified power consumption amounts, thereby computing the amount of consumable power required for the one or more designated actions that are scheduled to be executed. If the checkpoints included on the scheduled flight route include the position of a facility for charging the battery in the flying vehicle 1, and the execution plan includes the flying vehicle 1 charging at the facility, then the setting unit 233 may identify a second power consumption amount based on the prescribed actions to be executed by the flying vehicle 1 from the starting point of the scheduled flight route to the position of the facility.

If the sum of the amount of consumable power required for the flying vehicle 1 to fly based on the post-addition flight plan and the amount of consumable power required for the one or more prescribed actions is less than the remaining capacity of the battery in the flying vehicle 1 that has been identified, then the additional flight plan is set. By setting such a condition, the flying vehicle 1 can complete the flight based on the flight plan and the prescribed actions based on the execution plan even when starting to fly from the current position.

Additionally, the first condition may include the condition that the flying vehicle 1 be able to fly at the starting point position at the starting point position flying time included in the flight plan. In this case, the setting unit 233 computes the distance between the current position of the flying vehicle 1 and the starting point position, and divides this distance by the flight speed of the flying vehicle 1, thereby computing the movement time required for the flying vehicle 1 to arrive at the starting point position after starting to fly from the current position. Then, if the time after the computed movement time has elapsed from the current time is earlier than the starting point position flying time, then the setting unit 233 determines that the condition that the flying vehicle 1 be able to fly at the starting point position at the starting point position flying time is satisfied, and sets the additional flight plan. By setting such a condition, the flying vehicle 1 can arrive at the starting point position of the scheduled flight route at the starting point position flying time indicated by the flight plan, and can execute the flight plan as scheduled.

Additionally, the first condition may include the condition that the flying vehicle 1 be able to communicate with the flight management apparatus 2 on the scheduled flight route indicated by the additional flight plan. In this case, the setting unit 233 acquires communicable area information indicating the communicable area of the flying vehicle 1 within an area including the position of the flying vehicle 1 and the starting point position of the scheduled flight route indicated by the additional flight plan. The setting unit 233 refers to the acquired communicable area information, and if all of the line segment connecting the position of the flying vehicle 1 to the starting point position of the scheduled flight route, or if a prescribed percentage of the line segment, are included in the communicable area, then the setting unit 233 determines that the condition that the flying vehicle 1 be able to communicate with the flight management apparatus 2 on the scheduled flight route is satisfied, and sets the additional flight plan. By setting such a condition, the flying vehicle 1 will not become incommunicable while flying from the current position to the starting point position of the scheduled flight route, and thus can be prepared for unexpected circumstances.

In this case, if the setting unit 233 has determined that the flying vehicle 1 is not able to communicate with the flight management apparatus 2 on the scheduled flight route indicated by the additional flight plan, then the additional flight plan may be changed, based on the communicable area indicated by the communicable area information, so that the scheduled flight route indicated by the additional flight plan passes through the communicable area. The setting unit 233 may change the starting point position so that the additional flight route from the position of the flying vehicle 1 to the starting point position is included within the communicable area. In this case, the setting unit 233 may change the starting point position on the condition that the additional flight route from the position of the flying vehicle 1 to the post-change starting point position and the flight route from the post-change starting point position to the ending point position satisfy the first condition.

Additionally, the setting unit 233 was described as setting the additional flight plan if the post-addition flight plan satisfies the first condition. However, this disclosure is not limited thereto, and the additional flight plan may be set in the case in which a second condition different from the first condition is also satisfied. For example, the setting unit 233 may set the additional flight plan if the vicinity of the position of the flying vehicle 1 indicated by the position information acquired by the acquisition unit 232 further satisfies a second condition. In this case, the second condition is that the vicinity of the position of the flying vehicle 1 indicated by the position information acquired by the acquisition unit 232 is an environment in which the flying vehicle 1 can communicate. For example, the setting unit 233 may refer to the communicable area information that has been acquired and may determine that the second condition is satisfied if a prescribed range from the position of the flying vehicle 1 indicated by the position information acquired by the acquisition unit 232 is within the communicable area.

Additionally, the second condition may include that there are no obstacles in the vicinity of the position of the flying vehicle 1 indicated by the position information acquired by the acquisition unit 232. For example, the setting unit 233 acquires three-dimensional map information for the vicinity of the position of the flying vehicle 1 indicated by the position information acquired by the acquisition unit 232. The acquisition unit 232 determines whether or not there is an obstacle in the vicinity of the position of the flying vehicle 1 based on the acquired three-dimensional map information. By doing so, the flight management apparatus 2 can set the additional flight plan in a state in which there are no obstacles around the flying vehicle 1 and the flying vehicle 1 can safely fly.

The output unit 234 outputs the additional flight plan information indicating the additional flight plan set by the setting unit 233. Specifically, the output unit 234 transmits, to the flying vehicle 1 before flying, the post-addition flight plan information indicating the post-addition flight plan, which is a flight plan obtained by adding the additional flight plan set by the setting unit 233 to the flight plan indicated by the flight plan information for the flying vehicle 1 stored in the storage unit 22. Additionally, the output unit 234 transmits, to the flying vehicle 1, flight instruction information indicating flight instructions based on the post-addition flight plan information. Upon receiving the post-addition flight plan information and the flight instruction information, the flying vehicle 1 flies based on the post-addition flight plan information.

If the first condition or the second condition is not satisfied and an additional flight plan was not set by the setting unit 233, then the output unit 234 may transmit, to the user terminal, error information indicating that the additional flight plan was not set. Additionally, the output unit 234 may include, in the error information, information indicating the reason that the first condition was not satisfied or the reason that the second condition was not satisfied. Additionally, if the result of subtracting the sum of the amount of consumable power required for the flying vehicle 1 to fly the scheduled flight route and the amount of consumable power required to execute the prescribed actions from the remaining capacity of the battery in the flying vehicle 1 is less than zero, and the additional flight plan was not set, then the output unit 234 may transmit, to the user terminal, error information indicating that the flying vehicle 1 cannot be flown based on the flight plan information due to insufficient remaining battery capacity. By doing so, the user of the flying vehicle 1 can be made to understand that the additional flight plan was not set, and can cancel or correct the flight plan.

### [Flow of Processing in Flight Management System S]

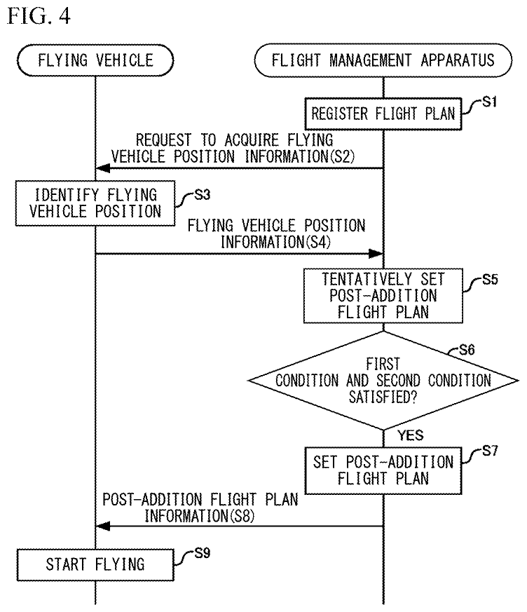

Next, the flow of the processing in the flight management system S will be explained. FIG. 4 is a sequence diagram indicating the flow of the processing in the flight management system S. The processing according to the present sequence diagram is performed in each of multiple flying vehicles 1.

First, the registration unit 231 of the flight management apparatus 2 receives a flight plan for a flying vehicle 1 from a user terminal of a user of the flying vehicle 1, and registers the flight plan (S1).

Next, an acquisition unit 232 in the flight management apparatus 2 refers to flight plan information for the flying vehicle 1 and transmits, to the flying vehicle 1, a flying vehicle position information acquisition request a prescribed time period before a starting point flying time included in the flight plan indicated by the flight plan information (S2).

The flying vehicle 1 identifies its own position (S3) and transmits the flying vehicle position information indicating its own position to the flight management apparatus 2 (S4).

If the position of the flying vehicle 1 indicated by the flying vehicle position information acquired by the acquisition unit 232 is different from a prescribed position on the scheduled flight route included in the flight plan of the flying vehicle 1, then the setting unit 233 in the flight management apparatus 2 tentatively sets a post-addition flight plan obtained by adding, to the flight plan of the flying vehicle 1, an additional flight plan from the position indicated by the flying vehicle position information to the starting point position of the scheduled flight route included in said flight plan (S5).

The setting unit 233 determines whether or not the post-addition flight plan that has been tentatively set satisfies the first condition and the second condition (S6). If the setting unit 233 determines that the post-addition flight plan satisfies the first condition and the second condition, then the processing shifts to S7, and the post-addition flight plan is set by updating the flight plan indicated by the flight plan information with the post-addition flight plan.

The output unit 234 transmits the post-addition flight plan information indicating the post-addition flight plan that has been set to the flying vehicle 1 (S8). Thereafter, the flying vehicle 1 starts to fly based on the post-addition flight plan indicated by the post-addition flight plan information (S9).

### [Modified Example]

In the explanation above, the setting unit 233 in the flight management apparatus 2 set an additional flight plan including an additional flight route from the position of the flying vehicle 1 indicated by the flying vehicle position information acquired by the acquisition unit 232 to the starting point position of the scheduled flight route included in the flight plan. However, this disclosure is not limited thereto. For example, if the position of the flying vehicle 1 indicated by the flying vehicle position information acquired by the acquisition unit 232 is different from the starting point position of the scheduled flight route, then the setting unit 233 may receive an additional flight route from the user of the flying vehicle via the user terminal, and may set an additional flight plan including the received additional flight route. By doing so, if the position of the flying vehicle 1 is different from the starting point position of the scheduled flight route, then the user may set the additional flight plan.

### [Effects of Present Embodiment]

As explained above, the flight management apparatus 2 sets an additional flight plan including an additional flight route from the position of the flying vehicle 1 to a prescribed position on a scheduled flight route, before the flying vehicle 1 flies based on the flight plan. By doing so, the flight management apparatus 2 can make the flying vehicle 1 fly without reducing the convenience to the user of the flying vehicle 1.

Due to the present embodiment, it is possible to contribute to Goal 9, “to build infrastructures for industrialization and to foster innovation” among the sustainable development goals (SDGs) advanced by the United Nations.

As mentioned above, various technologies have been proposed in connection with flight management apparatuses and flight management methods for managing the flight of flying vehicles.

In the conventional art, flight plans were set on the assumption that the flying vehicle would take off from a state in which the flying vehicle is housed in a housing apparatus. For this reason, when flying a flying vehicle, it was required to house the flying vehicle in a housing apparatus, thus reducing the convenience to users.

According to at least one exemplary embodiment, for example, the effect of being able to make a flying vehicle fly without reducing the convenience to the user is obtained.

While this disclosure has been explained by referring to embodiments above, the technical scope is not limited to the scope described among the embodiments above, and various modifications and changes can be made within the scope and spirit thereof. For example, all or part of the apparatus may be configured by being functionally or physically distributed or integrated in arbitrary units. Additionally, new embodiments obtained by arbitrarily combining multiple embodiments are also included among the present embodiments. The effects of the new embodiments created by these combinations are a combination of the effects of the original embodiments.

While preferred embodiments of this disclosure have been described and illustrated above, it should be understood that these are exemplary of this disclosure and are not to be considered as limiting. Additions, omissions, substitutions, and other modifications can be made without departing from the spirit or scope of this disclosure. Accordingly, this disclosure is not to be considered as being limited by the foregoing description, and is only limited by the scope of the appended claims.

What is claimed is:

1. A flight management apparatus comprising:
a storage unit that stores flight plan information indicating a flight plan for a flying vehicle, including a scheduled flight route for the flying vehicle;
an acquisition unit that acquires position information indicating a position of the flying vehicle from the flying vehicle before the flying vehicle flies based on the flight plan;
a setting unit that sets an additional flight plan including an additional flight route from the position indicated by the position information acquired by the acquisition unit to a prescribed position on the scheduled flight route included in the flight plan; and
an output unit that outputs additional flight plan information indicating the additional flight plan set by the setting unit.

2. The flight management apparatus according to claim 1, wherein
the setting unit sets the additional flight plan including the additional flight route from the position indicated by the position information acquired by the acquisition unit to a position of a starting point of the scheduled flight route included in the flight plan.

3. The flight management apparatus according to claim 1, wherein
the setting unit sets the additional flight plan by receiving approval for the additional flight plan from a user of the flying vehicle.

4. The flight management apparatus according to claim 1, wherein
the setting unit receives the additional flight route from the user of the flying vehicle and sets the additional flight plan including the received additional flight route.

5. The flight management apparatus according to claim 1, wherein
the setting unit sets the additional flight plan if a post-addition flight plan, which is a flight plan obtained by adding the additional flight plan to the flight plan, satisfies a first condition.

6. The flight management apparatus according to claim 5, wherein
the setting unit identifies a remaining capacity of a battery provided in the flying vehicle, and sets the additional flight plan if the first condition, which includes a relationship between the identified remaining capacity of the battery and the post-addition flight plan being a prescribed relationship, is satisfied.

7. The flight management apparatus according to claim 6, wherein
the setting unit sets the additional flight plan if an amount of consumable power required for the flying vehicle to fly in accordance with the post-addition flight plan is less than the identified remaining capacity of the battery.

8. The flight management apparatus according to claim 5, wherein
the flight plan includes an execution plan for a prescribed action that can be executed by the flying vehicle; and
the setting unit sets the additional flight plan if the first condition, which includes the flying vehicle being able to perform the prescribed action scheduled to be executed by the execution plan included in the post-addition flight plan, is satisfied.

9. The flight management apparatus according to claim 5, wherein
the flight plan includes time information indicating a time at which the flying vehicle is to fly at the prescribed position on the scheduled flight route; and
the setting unit sets the additional flight plan if the first condition, which includes the flying vehicle being able to fly at the prescribed position at the time at which to fly at the prescribed position indicated by the time information included in the flight plan, is satisfied.

10. The flight management apparatus according to claim 5, wherein
the setting unit sets the additional flight plan if the first condition, which includes the flying vehicle being able to communicate with the flight management apparatus on the scheduled flight route indicated by the additional flight plan, is satisfied.

11. The flight management apparatus according to claim 1, wherein
the setting unit sets the additional flight plan if a vicinity of the position indicated by the position information acquired by the acquisition unit satisfies a second condition.

12. The flight management apparatus according to claim 11, wherein
the setting unit sets the additional flight plan if the second condition, indicating that the vicinity of the position indicated by the position information acquired by the acquisition unit is an environment in which the flying vehicle can communicate, is satisfied.

13. The flight management apparatus according to claim 1, wherein
the setting unit sets the additional flight plan including the additional flight route, including a route ascending from the position indicated by the position information acquired by the acquisition unit to a position directly above the position and at the same altitude as the prescribed position.

14. The flight management apparatus according to claim 1, wherein
the output unit transmits post-addition flight plan information indicating a post-addition flight plan, which is a flight plan obtained by adding the additional flight plan set by the setting unit to the flight plan, to the flying vehicle before flying.

15. A flight management method, to be executed by a computer, the flight management method comprising:
storing, in a storage unit, flight plan information indicating a flight plan for a flying vehicle, the flight plan information including a scheduled flight route for the flying vehicle in the flight plan;
acquiring position information indicating a position of the flying vehicle from the flying vehicle before the flying vehicle flies based on the flight plan;
setting an additional flight plan including an additional flight route from a position indicated by the acquired position information to a prescribed position on the scheduled flight route included in the flight plan; and
outputting additional flight plan information indicating the additional flight plan that was set.
